(19) United States
(12) Patent Application Publication
(10) Pub. No.: US 2025/0269850 A1
(43) Pub. Date: Aug. 28, 2025

(54) Method and Assistance System for Easily Adjusting Driving Dynamics of a Motor Vehicle, and Correspondingly Designed Motor Vehicle

(71) Applicant: Bayerische Motoren Werke Aktiengesellschaft, Muenchen (DE)

(72) Inventor: Florian ROHRMUELLER, Landshut (DE)

(21) Appl. No.: 18/858,383

(22) PCT Filed: Jul. 7, 2023
(86) PCT No.: PCT/EP2023/068905

§ 371 Date: Oct. 21, 2024

(30) Foreign Application Priority Data
Jul. 11, 2022 (DE) 10 2022 117 220.1

(51) Int. Cl. B60W 30/14; B60W 50/10

(52) U.S. Cl. CPC B60W 30/143; B60W 50/10; B60W 2540/10; B60W 2554/4041; B60W 2720/10; B60W 2720/106

(57) ABSTRACT

A method and an assistance system for adjusting driving dynamics of a motor vehicle including, monitoring actuations of a control element in an operating mode comprising at least assisted longitudinal control, in which operating mode the speed of the motor vehicle is controlled by a vehicle guidance system. Only when such a detected actuation of the control element is identified as tapping, the driving dynamics for the longitudinal control are then automatically increased in a predefined manner at least for the current driving situation at that time. The at least assisted longitudinal control of the motor vehicle by the vehicle guidance system remains active in the process.

### BACKGROUND AND SUMMARY

The present invention relates to a method and assistance system for adapting a driving dynamics of a motor vehicle in accordance with requirements. The invention further relates to a correspondingly configured motor vehicle.

There are currently a large number of assistance systems and functions for motor vehicles, for example, for assisted or partially automated longitudinal guiding. In such current assistance systems for the longitudinal guiding, such as, for example, an adaptive cruise control (ACC) or the like, however, there are specific limitations as a result of system limits, for example, with regard to the dynamics, the reaction time and/or the like. This may, for example, relate to a start-up dynamics or an acceleration when driving behind a departing or turning vehicle in front or the like. It has been found that the behavior of such assistance systems in a conventional safety-orientated standard setting often does not use the space available for safe vehicle maneuvers and consequently cannot meet the wishes and preferences of at least some drivers, for example, for a faster and more dynamic driving manner.

As one approach, EP 1 912 843 B1 describes a driver assistance system for a motor vehicle having a controller for controlling the acceleration of the motor vehicle in question in accordance with a desired acceleration. Furthermore, a coupling member for coupling an additional acceleration which can be predetermined by the driver of the motor vehicle is provided. This additional acceleration can in this instance be predetermined by a manual operating element. As a result of the values produced by the operating element via the driver, the desired acceleration produced by the system is modified in such a manner that the action of the system is continuously decreased and the action of the driver operation is increased. Consequently, an improved driver assistance system for controlling the acceleration of the motor vehicle is intended to be provided.

As another approach, DE 10 2018 202 780 A1 describes an apparatus for operating a vehicle which can be driven in an at least partially automated manner and which has an operating element which can be operated by a driver for controlling at least the transverse guiding of the motor vehicle. Furthermore, there is provided therein a wheel angle adjuster which, in a state controlled by the operating element and/or by a control unit which controls the automated transverse guiding, controls a steering angle at the steerable wheels of the vehicle. The apparatus has at least one interpretation operating mode which differs from a substantially manual operating mode. In this interpretation operating mode, one or more operating actions which are initiated by the driver on the operating element are interpreted in accordance with the degree of haptic contact of the driver with the operating element. Consequently, an intelligent interaction between a vehicle which can be driven automatically and a driver is intended to be indicated or enabled, which interaction opens up a new possibility or a new driving experience for the driver.

An object of the present invention is to enable a particularly comfortable longitudinal guiding, which is at least assisted in accordance with requirements, of a motor vehicle.

This object is achieved with the aspects of subject-matter of the present disclosure. Other possible embodiments of the invention are disclosed in the description and the Figures. Features, advantages and possible embodiments which are set out in the context of the description for one of the aspects of subject-matter of the independent claims are intended to be regarded at least in a similar manner as features, advantages and possible embodiments of the respective subject-matter of the other independent claims and each possible combination of the aspects of subject-matter of the independent claims, where applicable in connection with one or more of the dependent claims.

The method according to the invention can be used to adjust or adapt a driving dynamics of a motor vehicle in accordance with requirements, in particular in a semi-automated manner. This may mean or involve, for example, a corresponding adjustment or adaptation of a value of at least one driving dynamic parameter which determines or influences the driving dynamics of the motor vehicle. In the method, in one operating mode of the motor vehicle having at least assisted or at least partially automated longitudinal guiding of the motor vehicle, wherein the speed of the motor vehicle is controlled by a vehicle guiding system of the motor vehicle, monitoring for activations of an operating element, which is predefined for this purpose, of the motor vehicle is carried out. This monitoring can be carried out in particular effectively in a permanent, that is to say, long-term or continuous or accordingly highly frequent manner. For example, the monitoring can be carried out by an assistance system which is configured for the method according to the invention. This may, for example, be part of the vehicle guiding system or may be able to be coupled or may be coupled in the respective motor vehicle to the vehicle guiding system, for example, by an on-board network of the motor vehicle or a data connection or interface or the like. In this operating mode, the speed of the motor vehicle is thus automatically controlled without the driver operating or activating the operating element on a permanent or regular basis.

The operating element may in particular be an accelerator pedal of the motor vehicle. This enables a particularly simple and intuitive operation. In addition, such an accelerator pedal is provided as standard in current motor vehicles so that the invention can be integrated and/or retrofitted in existing motor vehicles in a particularly simple and non-complex manner in existing production processes. However, the operating element may also be configured, for example, as a button or rocker or push-plate or touch-sensitive sensor or operating surface or the like. The operating element can then be arranged, for example, on a steering wheel, an instrument panel, a center console or the like. This may, where applicable, enable particularly easy capacity for access or operation of the operating element for the driver, particularly since the driver in the operating mode mentioned does not necessarily have to have his/her foot positioned on the accelerator pedal.

In the method according to the invention, only when in the context of the monitoring a detected activation of the operating element is identified as touching, that is to say, as a touch activation or trigger activation or brief activation of the operating element, in the operating mode mentioned is the driving dynamics increased in a predefined manner for the at least assisted or at least partially automated longitudinal guiding of the motor vehicle automatically at least partially, in particular only for the current driving situation in each case, that is to say, for the current driving maneuver in each case. In this instance, the at least assisted or at least partially automated longitudinal guiding of the motor vehicle as a result of the vehicle guiding system remains active, in particular in an uninterrupted manner. In other words, therefore as a result of the touching of the operating element, the at least assisted or partially automated longitudinal guiding or the corresponding speed control is not stopped or interrupted by the vehicle guiding system, the monitoring or control of the motor vehicle is thus not transferred temporarily or permanently to the driver.

The present invention is based in other words on the notion of permitting a situational dynamic increase by a brief driver operating action-for instance, in comparison with regular activations or operating actions for effectively changing the speed of the motor vehicle. As a result of such a deliberate driver action, that is to say, the-typically only deliberately and intentionally possible or occurring-brief touching of the operating element, an uncertainty and blurring in an automatic sensor detection or in an automatic interpretation, for example, of the vehicle guiding system, of sensor data of an environment sensor system can be overridden. Accordingly, a more dynamic, for example, more powerfully accelerating driving mode or vehicle control or speed control can then be permitted, that is to say, for instance, carried out by the vehicle guiding system. An increase of the driving dynamics can in the present sense also mean or involve a raising or reduction in value of a brake force adjusted by the vehicle guiding system or brake acceleration.

Consequently, the present invention provides in contrast to previous systems the possibility and the advantage that the driver operating action, in this instance, therefore, the activation of the operating element in the form of touching, does not constitute or mean under some circumstances longer-term, at least temporary transfer of the longitudinal control by the driver, that is to say, a manual overriding of the automatic regulation or control by the operating element, or is not interpreted as such or does not bring about such a transfer, particularly when the operating element is the accelerator pedal of the motor vehicle. Instead, the touching activation of the operating element is interpreted in this instance in the sense of a functional activation or a trigger for the function for automatic or semi-automatic driving dynamics increase.

The method according to the invention can thus in particular be used for semi-automatic adaptation of a longitudinal guiding dynamics of the corresponding vehicle guiding system of the respective motor vehicle. The present invention affords in this instance the advantage of improved comfort compared with conventional systems and a particularly simple and particularly rapid adaptability of the automatic behavior of the motor vehicle or the vehicle guiding system by the driver at least for a respective current driving situation. Previously, limits, for example, of the environment detection by a corresponding sensor system and/or the interpretation of corresponding sensor data led to a situationally limited dynamics of the automatic longitudinal guiding or longitudinal control. This can lead to a driving manner which is slow or perceived by the driver to be slow, for example, in comparison with surrounding traffic events and/or in comparison with the driver's own wishes or preferences. In previous motor vehicles, the driver typically only has the possibility of cancelling this or reacting to it by taking over the manual control or regulation of the motor vehicle, that is to say, overriding the automatic control, for example, by correspondingly forceful and/or permanent activation of the accelerator pedal in order to adjust or control a desired dynamics himself/herself. As a result of the present invention, this operating complexity can for the most part be saved and at the same time a driving dynamics which is adapted to the driver's wishes can nevertheless be enabled.

The touching of the operating element in the present sense may, for example, be or be interpreted to be similar to the usual activation of a button. The touching may thus be a brief activation directly followed by a release or an end of the activation which generally would not lead to a significant change of the speed or the driving behavior or driving state of the motor vehicle. For example, a brief activation, that is to say, a touching of the operating element, may be present when the activation thereof lasts, for example, less than 1 sec or less than 0.5 sec or the like. This duration may accordingly be configured or adapted, that is to say, predetermined, in accordance with the application or requirements. In particular, the increase of the driving dynamics, that is to say, the extent or degree of increase or change of the driving dynamics, can be predetermined and consequently independent of the duration or depth or force of the activation of the operating element as long as this activation is identified as touching. The change of the driving dynamics may thus be decoupled, for example, in terms of the duration and/or intensity thereof from more precise properties or a precise application of the individual touching. This must be considered to be in contrast, for example, to a conventional activation of an acceleration pedal, which is different from a touching in the present context when manually controlling or guiding the motor vehicle and which for example, with a longer duration and greater redirection leads to another effect—that is to say, for example, to a proportionally longer or greater acceleration. The touching in the transferred sense may also mean, that is to say, be or comprise, triggering or activation, that is to say, a discrete operator action or an individual activation or individual operator action. This may, for example, relate to corresponding operating elements or operating devices which are not configured for a longer-term or similar operation. Therefore, the touching may in this context mean or involve, for example, carrying out a predetermined operating gesture, a visual activation of an operating element or a corresponding operating device which is configured for visual or eye control, expressing a speech command and/or the like.

The adaptation or increase of the driving dynamics with respect to such a touching of the operating element can in each case last, that is to say, be maintained until the end or conclusion of the current respective driving situation or the respective current driving maneuver. Such a driving situation may, for example, be terminated when a start-up maneuver is complete, in the context of an acceleration maneuver, a target or set speed is achieved, a bend has been completely travelled, a lane change or an overtaking maneuver has been completed and/or the like. For example, therefore, in the case of a start-up or acceleration behind a preceding vehicle which is starting up, the driver by touching the operating element can trigger, that is to say, initiate an earlier or immediate starting-up operation and/or an automatic acceleration which is increased, for example, in comparison with a predetermined standard setting. Therefore, a slow driving sensation or a slow driving manner in the case of speed which is automatically controlled by the vehicle guiding system can thereby be cancelled in a particularly simple manner. In particular, the driver does in this instance or in addition, for example, not have to take over the manual control or monitoring of the motor vehicle and accordingly also does not have to subsequently, for example, activate the vehicle guiding system again.

In one possible embodiment of the present invention, a touching of the operating element as such is identified with reference to a movement profile of the operating element as provided for this purpose. The predetermined movement profile may thus indicate a movement of the operating element in the event of a touching or an activation which is defined as a touching. It is thus possible—in particular as a result of the assistance system mentioned—to detect the movement of the operating element during the activation and to compare it with the predetermined movement profile. If there are no deviations or only deviations which lie within predetermined tolerances in this case, the respective activation of the operating element may be identified as touching. Such a predetermined movement profile can as a result of correspondingly precise parametrization enable a particularly reliable identification of touch activations. For example, such touch activations can consequently be distinguished from other activations of the operating element which may differ from a touching, for instance, with regard to the acceleration path of the movement of the operating element, the extent of this movement, the symmetry or asymmetry between pressing-in and releasing the operating element and/or the like.

In another possible embodiment of the present invention, a detected activation of the operating element is identified as touching when the duration of the activation corresponds at the most to a maximum activation duration predetermined for such a touching and/or when a maximum redirection of the operating element during the activation or as a result of the activation starting from a position of the operating element as provided directly before or at the beginning of the respective activation corresponds at the most to a predefined maximum redirection for such a touching. The maximum redirection may thus indicate a maximum depth or a maximum extent of the activation or the movement of the operating element. In order to identify the or a touching, therefore, the duration of the activation before it has begun, that is to say, from an initial initiation of the previously automatically set position up to the end of the activation, that is to say, for example, particularly when the operating element is the accelerator pedal—up to the end of an application of force to the operating element by the driver and/or until the operating element has returned into the position of the operating element as provided directly before or at the beginning of the activation, or the like, can be established and compared with the predefined maximum activation duration, that is to say, with a corresponding predetermined threshold value. The same applies accordingly to the identification of the touching based on the detected maximum redirection of the operating element during the activation. As a result of the configuration of the present invention as proposed in this instance, a particularly precise, safe and reliable identification of touching activations, that is to say, a correspondingly precise and reliable distinction from other activations of the operating element, can be achieved or enabled.

In another possible embodiment of the present invention, the increase of the driving dynamics means or includes an increase of an acceleration, which is automatically adjusted or sought by the vehicle guiding system, of the motor vehicle. In other words, therefore, by touching the operating element, it is possible to cause the vehicle guiding system at least for the current driving situation or the corresponding maneuver to adjust or seek a greater or increased or raised acceleration value. This may be understood in corresponding driving situations, for example, in comparison with a previous adjustment for the acceleration and/or a predetermined standard acceleration and/or a predetermined standard parametrization for the speed control or for the longitudinal guiding of the motor vehicle by the vehicle guiding system. The increase of the acceleration as proposed in this instance may be carried out at least or only when it does not lead to an automatically identifiable, predictable collision or swerving of the motor vehicle or the like. The increase of the adjusted or sought acceleration may in a particularly effective manner lead or contribute to a more dynamic driving sensation or driving impression.

In another possible embodiment of the present invention, the increase of the driving dynamics means or involves an adjustment of an earlier or immediate beginning of an acceleration. This may, for instance, be understood in comparison with a previous adjustment for the acceleration and/or a predetermined standard parametrization for the speed control or for the longitudinal guiding of the motor vehicle by the vehicle guiding system in corresponding driving situations. Such an acceleration may, for example, in the context of the respective driving situation or the respective driving maneuver, be planned or provided in any case, but would normally begin later as standard. An earlier or immediate beginning of the acceleration can thus shorten or prevent waiting times which may result from a, for example, incomplete or still uncertain identification or interpretation of the surrounding traffic situation by the vehicle guiding system, corresponding calculation times and/or the like. In this instance, this is possible without any loss of safety since the earlier or immediate acceleration was actively initiated by the driver. As a result of a proposed earlier or immediate beginning of the acceleration—which is still automatic but controlled with adapted values—a slow driving sensation or a slow driving impression can be avoided in a particularly effective manner.

In another possible embodiment of the present invention, it is established whether, at the time of the touching of the operating element, a preceding vehicle which is still or was previously driving directly in front of the motor vehicle and which is moving out of the vehicle path of the motor vehicle is selected as a target or reference object for the longitudinal guiding of the motor vehicle, for instance, by the vehicle guiding system. Such a target or reference object may, for example, be the object or vehicle to which an adaptive cruise control maintains the corresponding spacing or the like. The fact that the vehicle in front is moving out of the vehicle path of the motor vehicle may, for example, mean or then be the case that or when the vehicle in front departs or turns or the like from the lane previously also travelled by the motor vehicle. If at the time of the touching such a vehicle in front is selected as a reference object, an earlier or immediate deselection of this preceding vehicle as a target or reference object for the longitudinal guiding of the motor vehicle is initiated as a result of the touching of the operating element in order to increase the driving dynamics. This may, for example, be carried out earlier in comparison with a previous adjustment for such a deselection or a corresponding change to a new target or reference object or in comparison with a predetermined standard parametrization for the longitudinal guiding or the speed control of the motor vehicle in corresponding driving situations or the like.

As a result of the touching of the operating element, the driver can in this instance thus virtually confirm or acknowledge or force such an earlier or immediate deselection of the respective front vehicle or vehicle driving in front and thereby, for example, initiate a correspondingly earlier dynamic increase or acceleration to a desired or adjusted set speed or a target speed for the respective path portion or the like. The embodiment of the present invention proposed in this instance enables the typically better or earlier correct estimation of the intention, that is to say, of the immediately imminent or current maneuver of the vehicle in front by the driver for the automatic or semi-automatic control or regulation of the longitudinal guiding of the motor vehicle to be used with particularly little operating complexity for the driver. Consequently, for example, situations can be prevented in which it is obvious to the driver that the respective vehicle in front will leave the travel path of the motor vehicle or has already for the most part left it, but the vehicle guiding system has not yet reacted to this since the vehicle in front is still at least partially in the travel path of the motor vehicle and consequently according to the safety-orientated interpretation of the vehicle guiding system represents an obstacle, which from the driver's viewpoint leads to a slow or delayed reaction of the vehicle guiding system. Consequently, as a result of the embodiment of the present invention proposed in this instance, in corresponding situations a particularly effective increase of the driving dynamics and a correspondingly improved driver impression for the driver can be achieved.

In another possible embodiment of the present invention, the driving dynamics can be increased or changed by several, in particular predetermined or predefined steps. When the operating element is touched several times in succession within the same driving situation, for each individual touching of the operating element the driving dynamics is increased by one step. This may, for example, be carried out cumulatively, that is to say, at once after the number of successive touch activations of the operating element has been detected or directly after each individual touch of the operating element. As a result of the multi-step adaptability of the driving dynamics as proposed in this instance, it can be adapted in a particularly precise and flexible manner to respective driver wishes or the respective situation, that is to say, accordingly adjusted by the driver in a particularly precise and flexible manner. In this instance, this is possible as a result of the operating scheme proposed here in a particularly simple, rapid and intuitive manner. As a result of the gradual or multi-step adaptation, an improved safety can further be achieved since excessively large and consequently potentially surprising changes of the driving behavior following a single operating action can be avoided.

The predetermined or predefined steps may, for example, be set out or defined as explicit value tables for respective parameters which are intended to be changed when the driving dynamics is adapted, as absolute or percentage changes or jumps, as support locations of a predetermined function and/or the like. For example, a desired acceleration for each individual touch of the operating element can be increased by 5% or by 10% or, for example, by 0.1 m/s² or the like. These values are intended to be understood purely by way of example and can be adapted depending on the application or requirements—whether it be by the manufacturer or via a corresponding configuration menu by the driver.

In another possible embodiment of the present invention, in the operating mode mentioned monitoring for activations of a second operating element of the motor vehicle is also carried out. The previously mentioned operating element for increasing the driving dynamics can for better differentiation also be referred to as the first operating element. When such an activation of the second operating element is detected and is identified as touching, the driving dynamics for the at least assisted or at least partially automated longitudinal guiding of the motor vehicle, at least, in particular only, are then decreased for the respective current driving situation in a predefined manner, that is to say, stepped down or reduced. In this instance, the at least assisted or at least partially automated longitudinal guiding of the motor vehicle by the vehicle guiding system, in particular in an uninterrupted manner, remains active. For example, the driving dynamics by touching the second operating element can be reset to an original value provided at the beginning or directly before the respective current driving situation or to a predetermined standard value or reduced by one of a plurality of predetermined or predefined steps. These steps may in particular be the steps mentioned at another point in connection with the driving dynamics which can be increased in multiple steps or may correspond to them. As a result of the configuration of the present invention as proposed here, an equally simple but even more precise and more flexible adaptation of the driving dynamics is enabled for the driver. The driver can thereby react, for example, to an incorrect assessment of the situation or to a temporary change of the situation to which the vehicle guiding system would potentially not react or would react only later when it relies on the estimation or specification of the driver which the driver has indicated by the previous touching of the first operating element, that is to say, for instance, the accelerator pedal. The second operating element may, for example, be in the form of a second button or second rocker or touch-sensitive sensor or operating surface or the like. The second operating element may also be in the form of a brake pedal, particularly when the first operating element is in the form of an accelerator pedal. The activation of the second operating element may also be defined as an alternative activation of the first operating element or a common or integrated operating element or a common or integrated operating device. The activation of the first and the second operating element may thus, for example, mean activations of the operating element in different operating directions. This may, for example, mean activating or tilting the rocker in the other direction or at the other side.

The present invention also relates to an assistance system for a motor vehicle. The assistance system according to the invention has an interface for detecting input data and for outputting control signals. Such input data may, for example, indicate or relate to pedal activations, a current operating mode of the motor vehicle, vehicle data, a vehicle state of the motor vehicle, a state of the vehicle guiding system, the current driving situation and/or the like. The control signals may, for example, be configured or output to control or initiate the vehicle guiding system to adapt the driving dynamics. The detection of the input data and the output of the control signals may, for example, be carried out via one and the same interface or via separate part-interfaces. Furthermore, the assistance system according to the invention has a process device, that is to say, for example, a microchip, a microprocessor or a microcontroller or the like and a coupled, computer-readable data store. The assistance system according to the invention is configured in particular to automatically or partially automatically carry out the method according to the invention. To this end, there may be stored in the data store, for example, a corresponding operating or computer program which encodes or implements the method steps, processes or measures mentioned in connection with the method according to the invention or corresponding control instructions. This operating or computer program may be able to be carried out by the process device in order to bring about the implementation of the corresponding method. The assistance system according to the invention may in particular be the assistance system mentioned in connection with the method according to the invention or correspond to it.

The invention also relates to a motor vehicle which has an operating element, in particular an accelerator pedal for manually controlling the speed of the motor vehicle, a vehicle guiding system for at least assisted or at least partially automated longitudinal guiding of the motor vehicle, in particular at a speed of the motor vehicle which is automatically controlled by the vehicle guiding system and an assistance system according to the invention which is coupled thereto, for example, directly or via an on-board network of the motor vehicle. The motor vehicle according to the invention may thus in particular be configured to automatically or partially automatically carry out or apply the method according to the invention. The motor vehicle according to the invention may in particular be the motor vehicle mentioned in connection with the method according to the invention and/or in connection with the assistance system according to the invention or correspond to it. Accordingly, the motor vehicle according to the invention may have some or all of the properties and/or features mentioned in these contexts, such as, for example, the brake pedal, the environment sensor system and/or the like.

Other features of the invention will be appreciated from the claims, the Figures and the description of the Figures. The features and feature combinations mentioned above in the description and the features and feature combinations shown below in the description of the Figures and/or in the Figures alone can be used not only in the combination set out, but also in other combinations or alone without departing from the scope of the invention.

### BRIEF DESCRIPTION OF THE DRAWINGS

FIG. 1 shows a schematic illustration of a motor vehicle which is configured for manual vehicle guiding and for at least assisted adaptable longitudinal guiding; and

FIG. 2 shows an exemplary, schematic flow chart for a method for operating the motor vehicle having at least assisted longitudinal guiding and the adaptation thereof.

### DETAILED DESCRIPTION OF THE DRAWINGS

Driver assistance systems which are currently available for longitudinal vehicle guiding are based on the following data processing chain: Sensor→Environment interpretation→Driving strategy and planning→Vehicle control. For example, as a result of sensor system limits, environmental influences, the latency of the processing chain, that is to say, the time from physical measurement or sensor detection up to the implementation of a corresponding reaction on the tire, a degree of sluggishness or reaction time of the driver assistance system may occur. Such driver assistance systems must also cope with incorrect and erroneous identifications. This is accordingly taken into account during the function configuration in order to ultimately nonetheless be able to produce a safe and comfortable driving method. Specifically, however, it may be the case that the driving dynamics, in particular the beginning and/or the intensity of accelerations which are adjusted or controlled or used by the driver assistance system in some situations are perceived from the driver's viewpoint to be delayed or too little. Below, it is explained with reference to the Figures how this problem can be counteracted.

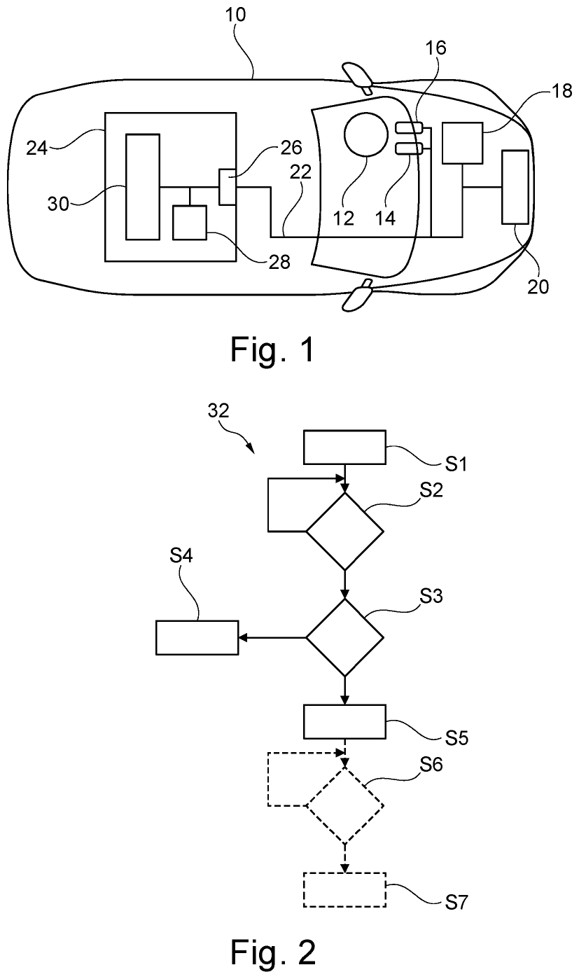

In this regard, FIG. 1 shows a schematic illustration of a motor vehicle 10 which can be controlled, that is to say, guided, in a manual driving mode by a driver 12. To this end, the motor vehicle 10 has, in this instance in a schematically illustrated state, an accelerator pedal 14 and a brake pedal 16. In this instance, however, the motor vehicle 10 is also configured for an at least assisted or at least partially automated driving mode at an automatically controlled speed. To this end, the motor vehicle 10 has a corresponding vehicle guiding system 18 and an environmental sensor system 20. These may, for example, be coupled to each other by an on-board network 22 which is indicated here schematically.

In order to be able to react to the problem of sluggishness discussed, the motor vehicle 10 further also has an assistance system 24. This system is in this instance in a schematically indicated state connected via an interface 26 to the on-board network 22 and has a processor 28 and a computer-readable data store 30.

A corresponding operating method for the motor vehicle 10 is explained with reference to FIG. 1 with reference to FIG. 2. FIG. 2 illustrates an exemplary schematic flow chart 32 for a method for semi-automatic adjustment or adaptation of the driving dynamics of the motor vehicle 10 in accordance with requirements. The method can be started in a method step S1. In this instance, for example, the motor vehicle 10, the vehicle guiding system 18 and the assistance system 24 can be started up or, for example, changed into the assisted or at least partially automated operating mode at an automatically controlled speed.

In a method step S2, a monitoring for activations of one or more operating elements is then started and continuously carried out. These operating elements may in this instance, for example, be the accelerator pedal 14 which then acts as a first operating element and the brake pedal 16 which then acts as a second operating element. In this case, consequently, a monitoring for pedal activations, that is to say, for activations of the accelerator pedal 14 or also of the brake pedal 16 by the driver 12 is started and continuously carried out. The operating elements may also be, for example, buttons or rockers or the like. If in this instance an operating element or pedal activation is detected, in a method step S3 by at least one predetermined criterion, it is checked whether the detected operating element or pedal activation is a touching of the accelerator pedal 14 or the brake pedal 16.

If this is not the case, and there is, for example, a longer and/or deeper pedal activation, in a method step S4, for example, the automatic longitudinal guiding or speed control can be stopped or overridden in accordance with the detected pedal activation.

Otherwise, when the detected pedal activation is a touching, in a method step S5 the driving dynamics is adapted accordingly. For example, following a touching of the accelerator pedal 14, the driving dynamics can be increased by a predefined step and following a touching of the brake pedal 16 can be decreased by a predefined step or reduced or reset to a standard value. In this instance, in each case the automatic longitudinal guiding or speed control by the vehicle guiding system 18 can remain continuously active.

Furthermore, for example, optionally, in a method step S6 it can be checked whether the current driving situation or the current driving maneuver is ended. This may be carried out regularly or continuously, as indicated in this instance by a corresponding looped path. If the current driving situation or the current driving maneuver has ended, for example, also optionally, in a method step S7, a previous setting or a standard parametrization for the automatic longitudinal guiding or speed control can be automatically adjusted again. Consequently, the next driving situation can then again be begun with this previous setting or standard parametrization, that is to say, handled by the vehicle guiding system 18.

At least the described steps or measures which have not been carried out by the vehicle guiding system 18 may in particular be carried out by the assistance system 24 automatically or semi-automatically.

On the whole, the examples described show how a situational dynamic increase or dynamic adaptation by assisted longitudinal guiding can be carried out by driver-initiated accelerator pedal touch activation.

### LIST OF REFERENCE NUMERALS

10 Motor vehicle
12 Driver
14 Accelerator pedal
16 Brake pedal
18 Vehicle guiding system
20 Environment sensor system
22 On-board network
24 Assistance system
26 Interface
28 Processor
30 Data store
32 Flow chart
S1-S7 Method steps

1-10. (canceled)

11. A method for adjusting a driving dynamics of a motor vehicle comprising:
in one operating mode of the motor vehicle having at least assisted longitudinal guiding, in which a speed of the motor vehicle is controlled by a vehicle guiding system of the motor vehicle, monitoring for activations of an operating element comprising an accelerator pedal of the motor vehicle; and
in response to identifying a detected activation of the operating element as touching of the operating element, subsequently automatically increasing the driving dynamics for the at least assisted longitudinal guiding at least for a respective current driving situation in a predefined manner, wherein the at least assisted longitudinal guiding of the motor vehicle by the vehicle guiding system remains active.

12. The method according to claim 11, comprising:
identifying the touching of the operating element using a predefined movement profile of the operating element.

13. The method according to claim 11, comprising:
identifying a detected activation of the operating element as touching in response to determining that a duration of the activation of the operating element corresponds at its most to a predefined maximum activation duration, and/or a maximum redirection of the operating element as a result of the activation starting from a position of the operating element as provided at a beginning of the respective activation corresponds at its most to a predefined maximum redirection.

14. The method according to claim 11, comprising:
increasing the driving dynamics including increasing an acceleration that is controlled by the vehicle guiding system of the motor vehicle.

15. The method according to claim 11, comprising:
increasing the driving dynamics including adjusting an earlier or immediate beginning of an acceleration.

16. The method according to claim 11, wherein
in response to, at a time of the touching of the operating element, a preceding vehicle which is still or was previously driving directly in front of the motor vehicle and which is moving out of a travel path of the motor vehicle is selected as a reference object for the longitudinal guiding of the motor vehicle, as a result of the touching of the operating element, an earlier or immediate deselection of the preceding vehicle as a reference object for the longitudinal guiding is initiated.

17. The method according to claim 11, comprising:
increasing the driving dynamics by several steps,
wherein, in response to the operating element being touched multiple times in succession within a same driving situation for each individual touching of the operating element, the driving dynamics is increased by one step.

18. The method according to claim 11, comprising:
monitoring for activations of a second operating element of the motor vehicle in the operating mode,
wherein, in response to identifying an activation of the second operating element as a touching of the second operating element, automatically reducing in a predefined manner the driving dynamics for the at least assisted longitudinal guiding of the motor vehicle at least for the respective current driving situation, wherein the at least assisted longitudinal guiding of the motor vehicle by the vehicle guiding system remains active.

19. An assistance system for a motor vehicle comprising:
an interface for detecting input data and for outputting control signals; and
a processor device configured to:
in one operating mode of the motor vehicle having at least assisted longitudinal guiding, in which a speed of the motor vehicle is controlled by a vehicle guiding system of the motor vehicle, monitor for activations of an operating element comprising an accelerator pedal of the motor vehicle; and
in response to identifying a detected activation of the operating element as touching of the operating element, subsequently automatically increase driving dynamics for the at least assisted longitudinal guiding at least for a respective current driving situation in a predefined manner, wherein the at least assisted longitudinal guiding of the motor vehicle by the vehicle guiding system remains active.

20. A motor vehicle comprising:
the assistance system according to claim 19; and
the operating element comprising the accelerator pedal configured to manually control a speed of the motor vehicle;
a vehicle guiding system configured to provide at least assisted longitudinal guidance of the motor vehicle; and
an assistance system coupled thereto.

21. The assistance system according to claim 19,
wherein the processor device is configured to:
identify the touching of the operating element using a predefined movement profile of the operating element.

22. The assistance system according to claim 19,
wherein the processor device is configured to:
identify a detected activation of the operating element as touching in response to determining that a duration of the activation of the operating element corresponds at its most to a predefined maximum activation duration, and/or a maximum redirection of the operating element as a result of the activation starting from a position of the operating element as provided at a beginning of the respective activation corresponds at its most to a predefined maximum redirection.

23. The assistance system according to claim 19,
wherein the processor device is configured to:
increase the driving dynamics including increasing an acceleration that is controlled by the vehicle guiding system of the motor vehicle.

24. The assistance system according to claim 19,
wherein the processor device is configured to:
increase the driving dynamics including adjusting an earlier or immediate beginning of an acceleration.

25. The assistance system according to claim 19, wherein
in response to, at a time of the touching of the operating element, a preceding vehicle which is still or was previously driving directly in front of the motor vehicle and which is moving out of a travel path of the motor vehicle is selected as a reference object for the longitudinal guiding of the motor vehicle, as a result of the touching of the operating element, an earlier or immediate deselection of the preceding vehicle as a reference object for the longitudinal guiding is initiated.

26. The assistance system according to claim 19,
wherein the processor device is configured to:
increase the driving dynamics by several steps,
wherein, in response to the operating element being touched multiple times in succession within a same driving situation for each individual touching of the operating element, the driving dynamics is increased by one step.

27. The assistance system according to claim 19,
wherein the processor device is configured to:
monitor for activations of a second operating element of the motor vehicle in the operating mode,
wherein, in response to identifying an activation of the second operating element as a touching of the second operating element, automatically reducing in a predefined manner the driving dynamics for the at least assisted longitudinal guiding of the motor vehicle at least for the respective current driving situation, wherein the at least assisted longitudinal guiding of the motor vehicle by the vehicle guiding system remains active.
